(19) United States
(12) Patent Application Publication
(10) Pub. No.: US 2026/0365232 A1
(43) Pub. Date: Nov. 19, 2026

(54) ELECTRIC POWER STEERING APPARATUS AND VEHICLE HAVING THE SAME

(71) Applicant: HL MANDO CORPORATION, Pyeongtaek-si (KR)

(72) Inventor: Dongsik KIM, Pyeongtaek-si (KR)

(73) Assignee: HL MANDO CORPORATION, Pyeongtaek-si (KR)

(21) Appl. No.: 19/374,636

(22) Filed: Oct. 30, 2025

(30) Foreign Application Priority Data
May 16, 2025 (KR) 10-2025-0063992

(51) Int. Cl. B62D 5/04; B60R 16/02

(52) U.S. Cl. CPC B62D 5/0463; B60R 16/0207; B62D 5/0403; B62D 5/0442

(57) ABSTRACT

The present embodiment relates to an electric power steering apparatus and a vehicle including the same. More specifically, the present embodiments may provide an electric power steering apparatus, in which an anti-rotation member may be fixed between a gearbox housing and a cover housing and support a torque sensor so as to prevent the torque sensor from rotating in a rotation direction of an input shaft or an output shaft or moving in a radial direction, thereby ensuring signal transmission stability of the torque sensor and preventing an erroneous operation of the torque sensor even though the torque sensor is used for a long period of time, and the anti-rotation member may be disposed above a worm wheel gear and cover a wire harness connector, thereby effectively preventing external foreign substances or a lubricant applied onto the worm wheel gear from being introduced into the wire harness connector, and a vehicle including the same.

### CROSS-REFERENCE TO RELATED APPLICATIONS

This application claims the priority of Korean Patent Application No. 10-2025-0063992 filed on May 16, 2025, in the Korean Intellectual Property Office, the disclosure of which is incorporated herein by reference.

### BACKGROUND

### Technical Field

The present embodiments relate to an electric power steering apparatus capable of preventing a rotation of a torque sensor and contamination of a sensor connector, and a vehicle having the same.

### Description of the Related Art

In general, a steering apparatus for a vehicle refers to an apparatus configured to determine a traveling direction of a wheel in accordance with a rotation of a steering wheel. The steering apparatus includes a rack bar formed in a transverse direction of the vehicle and having a rack gear provided at one side of an outer peripheral surface of the rack bar, an output shaft having a pinion gear configured to engage with the rack gear, an input shaft connected to the steering wheel, a torque sensor assembled between the input shaft and the output shaft, a rack housing in which the rack bar is embedded, and a gearbox housing and a cover housing in which the input shaft, the output shaft, the torque sensor, and the like are embedded.

In the steering apparatus, the input shaft, the output shaft, and the torque sensor are installed in the gearbox housing, a wire harness connector is coupled to the torque sensor, and a wire harness penetrates one side of the gearbox housing and is electrically connected to the wire harness connector.

However, in this structure, the torque sensor may rotate in a rotation direction of the input shaft or the output shaft or be finely displaced during a process in which the torque sensor receives a rotational force. In case that an external fixing part is not provided separately, a fixed state of the torque sensor cannot be maintained while the torque sensor is used for a long period of time, which causes an erroneous operation.

In addition, in a structure in which the torque sensor is disposed above a worm wheel gear, a lubricant, such as grease, applied onto the worm wheel gear is introduced into the wire harness connector, which causes contamination.

### BRIEF SUMMARY

The present embodiments may provide an electric power steering apparatus, in which an anti-rotation member may be fixed between a gearbox housing and a cover housing and support a torque sensor so as to prevent the torque sensor from rotating in a rotation direction of an input shaft or an output shaft or moving in a radial direction, thereby ensuring signal transmission stability of the torque sensor and preventing an erroneous operation of the torque sensor even though the torque sensor is used for a long period of time, and the anti-rotation member may be disposed above a worm wheel gear and cover a wire harness connector, thereby effectively preventing external foreign substances or a lubricant applied onto the worm wheel gear from being introduced into the wire harness connector, and a vehicle including the same.

In one aspect, the present embodiments may provide an electric power steering apparatus including: a gearbox housing having one side to which a cover housing is coupled, and the other side to which a rack housing is coupled; a pinion shaft including an input shaft rotatably coupled to the cover housing, and an output shaft coupled to the input shaft by means of a torsion bar and rotatably coupled to the gearbox housing; a torque sensor installed on the pinion shaft and configured to detect a relative rotation angle between the input shaft and the output shaft; and an anti-rotation member coupled to the torque sensor and supported on the gearbox housing or the cover housing to prevent the torque sensor from rotating in a rotation direction of the input shaft or the output shaft.

In another aspect, the present embodiments may provide a vehicle including: a traveling route setting part; a steering angle determining part configured to determine a steering angle based on a traveling route set by the traveling route setting part; and an electric power steering apparatus configured to assist an operating force of a steering wheel or perform steering based on the steering angle determined by the steering angle determining part, in which the electric power steering apparatus includes: a gearbox housing having one side to which a cover housing is coupled, and the other side to which a rack housing is coupled; a pinion shaft including an input shaft rotatably coupled to the cover housing, and an output shaft coupled to the input shaft by means of a torsion bar and rotatably coupled to the gearbox housing; a torque sensor installed on the pinion shaft and configured to detect a relative rotation angle between the input shaft and the output shaft; and an anti-rotation member coupled to the torque sensor and supported on the gearbox housing or the cover housing to prevent the torque sensor from rotating in a rotation direction of the input shaft or the output shaft.

The present embodiments may provide the electric power steering apparatus, in which the anti-rotation member may be fixed between the gearbox housing and the cover housing and support the torque sensor so as to prevent the torque sensor from rotating in the rotation direction of the input shaft or the output shaft or moving in the radial direction, thereby ensuring the signal transmission stability of the torque sensor and preventing an erroneous operation of the torque sensor even though the torque sensor is used for a long period of time, and the vehicle including the same.

In addition, the present embodiments may provide the electric power steering apparatus, in which the anti-rotation member may be disposed above the worm wheel gear and cover the wire harness connector, thereby effectively preventing external foreign substances or the lubricant applied onto the worm wheel gear from being introduced into the wire harness connector, and the vehicle including the same.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a configuration view illustrating a vehicle provided with an electric power steering apparatus according to the present embodiment;

FIG. 2 is a view schematically illustrating a structure of an electric power-assisted steering apparatus for a vehicle;

FIG. 3 is a view schematically illustrating a structure of a steer-by-wire steering apparatus for a vehicle;

FIG. 4 is a perspective view illustrating a part of the electric power steering apparatus according to the present embodiment;

FIG. 5 is a perspective view illustrating a part of the electric power steering apparatus according to the present embodiment;

FIG. 6 is a cross-sectional view illustrating a part of the electric power steering apparatus according to the present embodiment;

FIG. 7 is an exploded perspective view illustrating a part of the electric power steering apparatus according to the present embodiment;

FIG. 8 is an exploded perspective view illustrating a part of the electric power steering apparatus according to the present embodiment;

FIG. 9 is a top plan view illustrating a part of the electric power steering apparatus according to the present embodiment;

FIG. 10 is a perspective view illustrating an anti-rotation member of the electric power steering apparatus according to the present embodiment;

FIG. 11 is a cross-sectional view illustrating a part of the electric power steering apparatus according to the embodiment;

FIG. 12 is a cross-sectional view illustrating a part of an electric power steering apparatus according to another embodiment;

FIG. 13 is a cross-sectional perspective view illustrating a part of an electric power steering apparatus according to still another embodiment; and

FIG. 14 is a cross-sectional perspective view illustrating a part of an electric power steering apparatus according to yet another embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

To further elaborate, as used herein, the term “coupled” is intended to have the broadest possible meaning. Specifically, the phrase “A is coupled to B” encompasses both a direct connection—where no intervening components or elements are present—and an indirect connection, where one or more intermediate components or elements exist between A and B. In other words, “A is coupled to B” includes both direct physical or electrical coupling and indirect coupling through one or more intervening components. Unless explicitly stated otherwise, these terms do not require direct physical or electrical contact. The term “connected” and “in contact” should be interpreted in the same manner.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

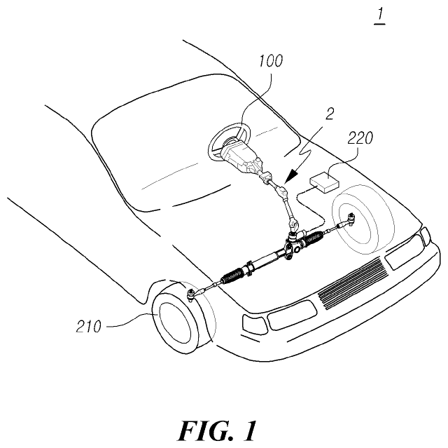

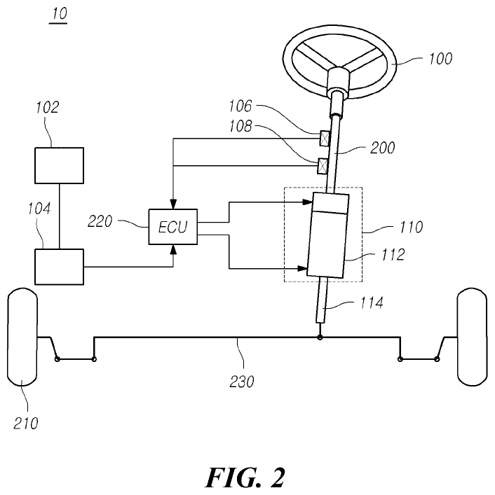

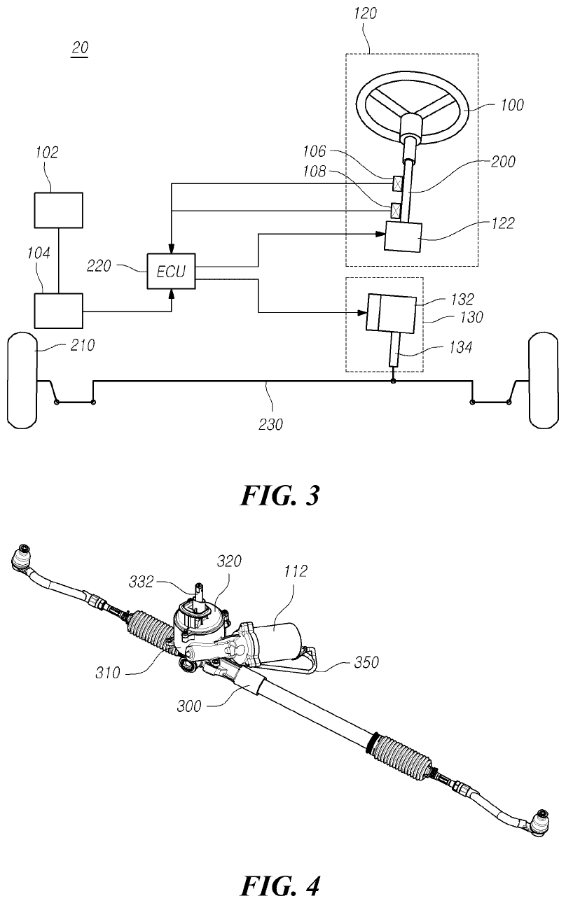

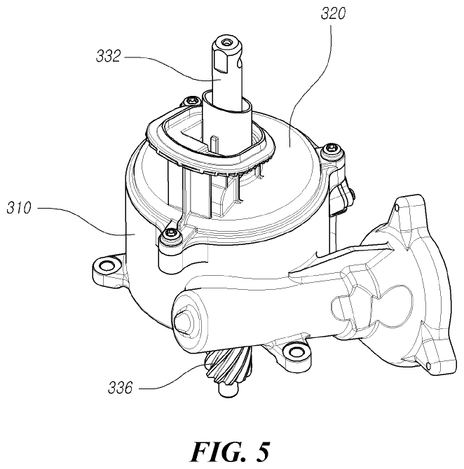

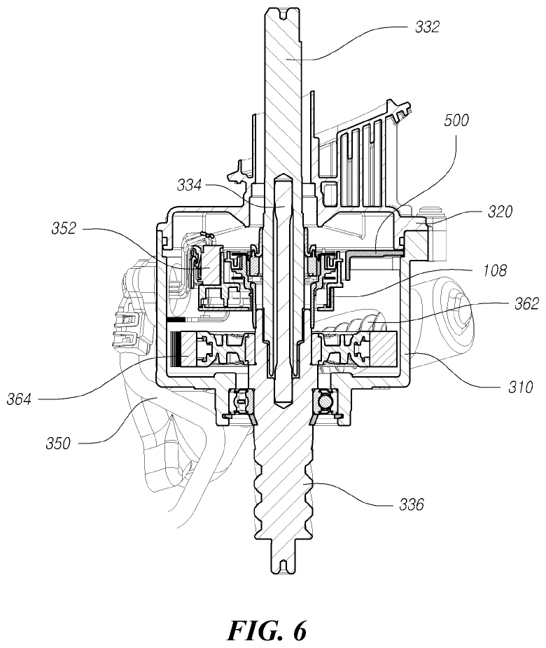

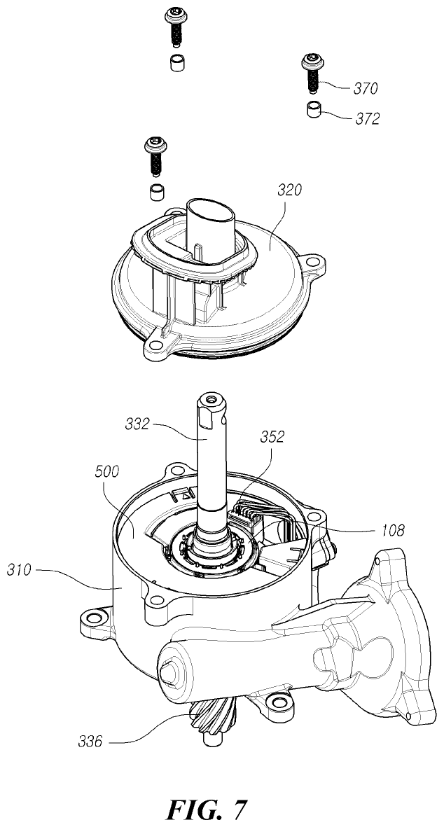

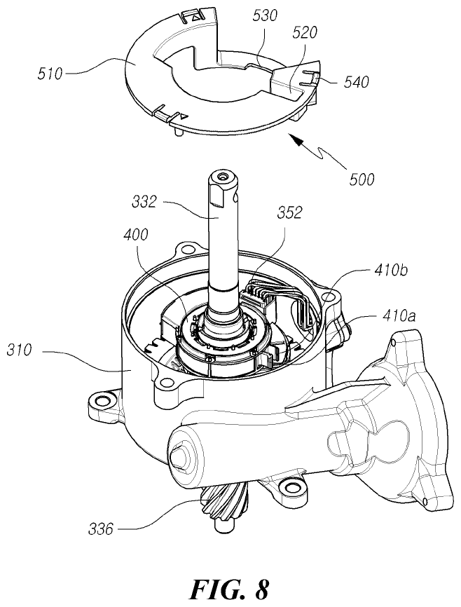

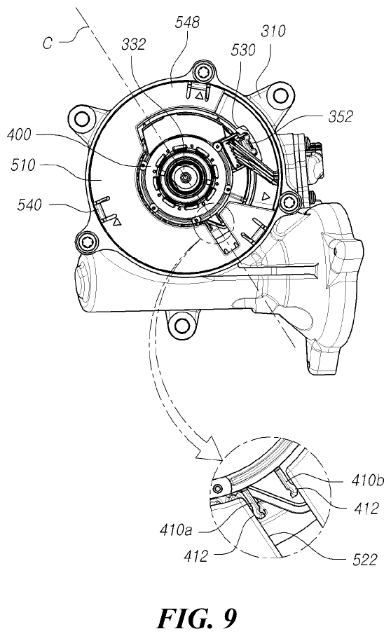

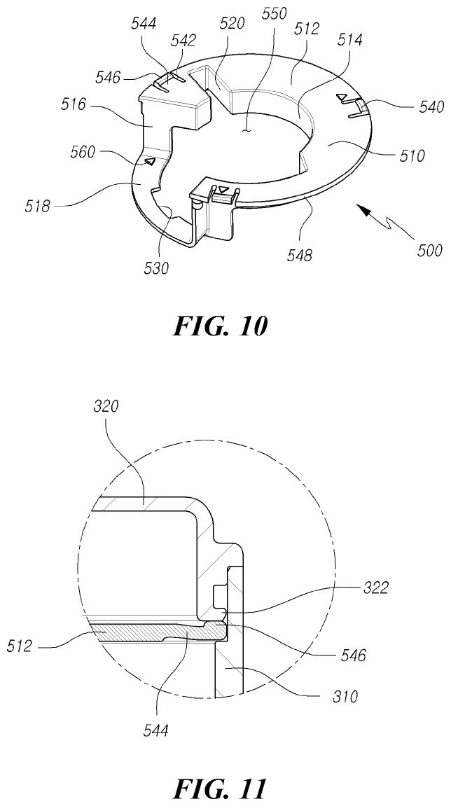

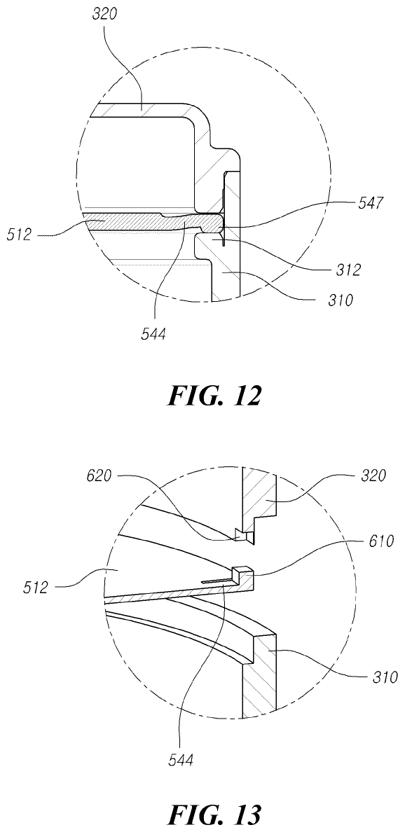

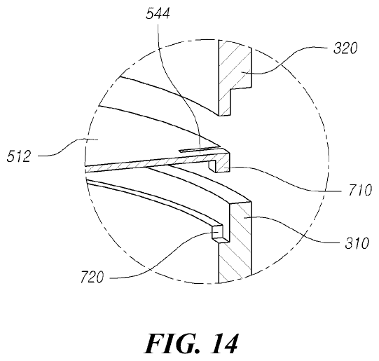

FIG. 1 is a configuration view illustrating a vehicle provided with an electric power steering apparatus according to the present embodiment, FIG. 2 is a view schematically illustrating a structure of an electric power-assisted steering apparatus for a vehicle, FIG. 3 is a view schematically illustrating a structure of a steer-by-wire steering apparatus for a vehicle, FIG. 4 is a perspective view illustrating a part of the electric power steering apparatus according to the present embodiment, FIG. 5 is a perspective view illustrating a part of the electric power steering apparatus according to the present embodiment, FIG. 6 is a cross-sectional view illustrating a part of the electric power steering apparatus according to the present embodiment, FIG. 7 is an exploded perspective view illustrating a part of the electric power steering apparatus according to the present embodiment, FIG. 8 is an exploded perspective view illustrating a part of the electric power steering apparatus according to the present embodiment, FIG. 9 is a top plan view illustrating a part of the electric power steering apparatus according to the present embodiment, FIG. 10 is a perspective view illustrating an anti-rotation member of the electric power steering apparatus according to the present embodiment, FIG. 11 is a cross-sectional view illustrating a part of the electric power steering apparatus according to the embodiment, FIG. 12 is a cross-sectional view illustrating a part of an electric power steering apparatus according to another embodiment, FIG. 13 is a cross-sectional perspective view illustrating a part of an electric power steering apparatus according to still another embodiment, and FIG. 14 is a cross-sectional perspective view illustrating a part of an electric power steering apparatus according to yet another embodiment.

Hereinafter, various embodiments will be described in detail with reference to the accompanying drawings.

With reference to FIGS. 1 to 3, a vehicle 1 may include a traveling route setting part 102, a steering angle determining part 104 configured to set a steering angle based on a traveling route set by a traveling route setting part 102, and an electric power steering apparatus 2 configured to assist an operating force of a steering wheel 100 or allow the steering wheel 100 to perform a steering operation based on the steering angle set by the steering angle determining part 104.

More specifically, the traveling route setting part 102 may set the traveling route in consideration of a current position, a destination, a traffic situation, and the like and transfer information on the set traveling route to the steering angle determining part 104.

Further, the steering angle determining part 104 may set a steering angle of the vehicle 1 based on the traveling route set by the traveling route setting part 102, determine the steering angle suitable for a traveling situation, and transfer information on the steering angle to a controller 220.

Further, the controller 220 may assist the operating force of the steering wheel 100 or allow the steering wheel 100 to perform the steering operation in accordance with the information on the steering angle transferred from the steering angle determining part 104.

In this case, the electric power steering apparatus 2 refers to an apparatus configured to determine traveling directions of wheels 210 in accordance with the rotation of the steering wheel 100. The electric power steering apparatus 2 may assist an input of a driver or completely autonomously control the vehicle 1.

Examples of the above-mentioned electric power steering apparatus 2 include an electric power-assisted steering system 10 configured to assist the operating force of the steering wheel 100 by using an electric motor, such as a motor, in order to provide convenience for a driving manipulation, and a steer-by-wire steering system 20 configured to steer the vehicle 1 by using an electric motor such as a motor. The electric power steering apparatus 2 according to the present embodiment may be applied to the electric power-assisted steering system 10 and the steer-by-wire steering system 20.

As illustrated in FIG. 2, in the electric power-assisted steering system 10, an angle sensor 106 and a torque sensor 108 are connected to one side of a steering shaft 200 connected to the steering wheel 100. When the driver manipulates the steering wheel 100, the angle sensor 106 and the torque sensor 108, which detect the manipulation, transmit electrical signals to the controller 220, and the controller 220 transmits an operational signal to a drive motor 112 of a steering actuator 110.

The controller 220 controls the drive motor 112 based on electrical signals transmitted from the angle sensor 106 and the torque sensor 108 and electrical signals transmitted from several other sensors mounted in the vehicle 1.

In the electric power-assisted steering system 10, when a rotational force of the drive motor 112 is transmitted to a pinion shaft 114, a pinion gear of the pinion shaft 114 engages with a rack gear and moves a rack bar 230 rectilinearly, thereby performing the steering operation.

As illustrated in FIG. 3, the steer-by-wire steering system 20 is provided with a steering device 120 disposed to be close to the driver, and a steering actuator 130 disposed to be close to the wheel 210. The angle sensor 106 and the torque sensor 108 are coupled to one side of the steering shaft 200 connected to the steering wheel 100. When the driver manipulates the steering wheel 100, the angle sensor 106 and the torque sensor 108, which detect the manipulation, send electrical signals to the controller 220 to operate a reaction force motor 122 and a drive motor 132.

The controller 220 controls the reaction force motor 122 and the drive motor 132 based on electrical signals transmitted from the angle sensor 106 and the torque sensor 108 and electrical signals transmitted from several other sensors mounted in the vehicle 1.

In the steer-by-wire steering system 20, when a rotational force of the drive motor 132 is transmitted to a pinion shaft 134, a pinion gear of the pinion shaft 134 engages with the rack gear and moves the rack bar 230 rectilinearly, thereby performing the steering operation.

In this case, the rack gear engages with the pinion gear and converts a rotational motion of the steering shaft 200 into a rectilinear motion of the rack bar 230.

In the present embodiment, for example, the electric power-assisted steering system 10 will be described in which when the driver manipulates the steering wheel 100, the rotational force is transmitted to the pinion shaft 114 through the steering shaft 200, and the pinion gear of the pinion shaft 114 engages with the rack gear and moves the rack bar rectilinearly to perform the steering operation.

In the detailed description of the present embodiment, unless otherwise specified, for convenience of description, the description will be made on the assumption that a side of an input shaft 332 connected to the steering wheel is defined as one side based on a central axis of the pinion shaft 114, and a side of an output shaft 336 opposite to the side of the input shaft 332 is defined as the other side.

With reference to FIGS. 4 to 10, the electric power steering apparatus 2 of the present embodiment includes a gearbox housing 310 having one side to which a cover housing 320 is coupled, and the other side to which a rack housing 300 is coupled, the pinion shaft 114 having the input shaft 332 rotatably coupled to the cover housing 320 and the output shaft 336 coupled to the input shaft 332 by means of a torsion bar 334 and rotatably coupled to the gearbox housing 310, the torque sensor 108 installed on the pinion shaft 114 and configured to detect a relative rotation angle between the input shaft 332 and the output shaft 336, and an anti-rotation member 500 coupled to the torque sensor 108 and supported on the gearbox housing 310 or the cover housing 320 to prevent the torque sensor 108 from rotating in a rotation direction of the input shaft 332 or the output shaft 336.

The electric power steering apparatus 2 includes the rack housing 300 configured to surround the steering shaft 200, the pinion shaft 114, the torque sensor 108, the anti-rotation member 500, the rack bar 230, and the rack bar 230, the gearbox housing 310 configured to surround the torque sensor 108 and the anti-rotation member 500, and the cover housing 320 configured to cover one side of the gearbox housing 310.

One side of the steering shaft 200 is connected to the steering wheel 100, and the other side of the steering shaft 200 is connected to the pinion shaft 114 by means of a pair of universal joints.

The pinion shaft 114 includes the input shaft 332 connected to the steering shaft 200 by means of the pair of universal joints, and the output shaft 336 connected to the input shaft 332 by means of the torsion bar 334.

The input shaft 332 is connected to the steering shaft 200 by means of the pair of universal joints. When the steering wheel 100 rotates, the input shaft 332 rotates by receiving a rotational force of the steering shaft 200.

The output shaft 336 is connected to the input shaft 332 by means of the torsion bar 334. The output shaft 336 rectilinearly reciprocates the rack bar 230 while rotating together with the input shaft 332 in conjunction with the input shaft 332.

In this case, in the electric power steering apparatus 2 according to the present embodiment, the pinion gear is formed on an outer peripheral surface of the output shaft 336, the rack gear is formed at one side of an outer peripheral surface of the rack bar 230, and the pinion gear engages with the rack gear and converts a rotational motion of the output shaft 336 into a rectilinear reciprocating motion of the rack bar 230.

The rack bar 230 is formed in a transverse direction of the vehicle, and two opposite ends of the rack bar 230 are connected to the wheels 210 of the vehicle through tie rods and knuckle arms.

In addition, the electric power steering apparatus 2 includes the angle sensor 106 configured to output an electrical signal proportional to a rotation angle of the steering wheel 100, the torque sensor 108 configured to detect torque applied to the steering wheel 100 by the driver and output an electrical signal proportional to the detected torque, the controller 220 configured to generate a control signal based on electrical signals transmitted from the angle sensor 106 and the torque sensor 108, the drive motor 112 configured to generate auxiliary power based on the control signal transmitted from the controller 220, and a speed reducer including a worm gear 362 and a worm wheel gear 364 configured to transmit the auxiliary power, which is generated by the drive motor 112, to the pinion shaft 114.

In this case, in the electric power steering apparatus 2, the torque sensor 108 is installed on the input shaft 332 and the output shaft 336, and a wire harness 350 is coupled to the torque sensor 108 by means of a wire harness connector 352.

In this case, the torque sensor 108 detects a relative rotation angle between the input shaft 332 and the output shaft 336 and converts the relative rotation angle into an electrical signal, and the torque sensor 108 transmits the electrical signal to the controller 220 through the wire harness 350 connected to the wire harness connector 352.

The cover housing 320 is coupled to one side of the gearbox housing 310 by fastening members 370, such as bolts, and covers one open side of the gearbox housing 310.

In this case, in the present embodiment, a guide member 372 is coupled between the cover housing 320 and the fastening member 370 in order to ensure alignment and coupling stability of a fastening position.

The guide member 372 guides an insertion route of the fastening member 370 to prevent deviation from the fastening position and prevent problems, such as tilting, insertion error, and housing damage, that may be caused by an external force during a fastening process.

The cover housing 320 is coupled to one side of the gearbox housing 310, and the rack housing 300, which surrounds the rack bar 230, is coupled to the other side of the gearbox housing 310.

In this case, in the gearbox housing 310, the input shaft 332 and the output shaft 336, which are connected by means of the torsion bar 334, are rotatably installed, the worm gear 362 and the worm wheel gear 364, which transmit auxiliary power generated by the drive motor 112 to the pinion shaft 114, are installed, and the torque sensor 108, to which the wire harness 350 is coupled by means of the wire harness connector 352, is installed, and the anti-rotation member 500, which fixes the torque sensor 108, is installed.

The rack housing 300 is formed to surround the rack bar 230 extending in the transverse direction of the vehicle, and the rack housing 300 is coupled to the other side of the gearbox housing 310, which is open toward the other side, by means of a fastening member such as a bolt.

The anti-rotation member 500 is coupled to the torque sensor 108 and supported on the cover housing 320 or the gearbox housing 310 to prevent the torque sensor 108 from rotating in the rotation direction of the input shaft 332 or the output shaft 336.

The anti-rotation member 500 is fixed by being fitted between the cover housing 320 and the gearbox housing 310 when the cover housing 320 and the gearbox housing 310 are coupled, and a stably fixed state of the anti-rotation member 500 is maintained by restoring forces of elastic deformable portions 544 even without requiring a separate fastening means.

More specifically, The electric power steering apparatus further includes a wire harness connector. the anti-rotation member 500 includes a cover part 510 formed in a shape that surrounds the wire harness connector 352 and the torque sensor 108 in order to prevent external foreign substances or a lubricant applied onto the worm wheel gear 364 from being introduced into the wire harness connector 352 or the torque sensor 108.

The cover part 510 includes a first cover plate 512 disposed between the cover housing 320 and the gearbox housing 310 and supported on the cover housing 320 or the gearbox housing 310 in order to cover one side of the torque sensor 108, a second cover plate 514 bent from the first cover plate 512 and extending to the other side in order to cover an outer surface of the torque sensor 108, a pair of third cover plates 516 bent from the first cover plate 512 and extending to the other side in order to cover two opposite sides of the wire harness connector 352, and a fourth cover plate 518 disposed in parallel with the first cover plate 512 so as to be disposed at the other side of the wire harness connector 352, the fourth cover plate 518 being coupled to the pair of third cover plates 516.

The first cover plate 512 is horizontally disposed between the cover housing 320 and the gearbox housing 310 so as to cover one side of the torque sensor 108.

The first cover plate 512 serves as a basic frame of the cover part 510 while protecting the torque sensor 108, and the first cover plate 512 is supported on the cover housing 320 or the gearbox housing 310.

The second cover plate 514 is bent from the first cover plate 512 toward the other side and extends.

The second cover plate 514 is configured to surround the outer surface of the torque sensor 108 and prevent the torque sensor 108 from being damaged by external impact or foreign substances or displaced.

The third cover plates 516 are provided as a pair of third cover plates 516, and the third cover plates 516 are bent from the first cover plate 512 toward the other side and extend.

The third cover plates 516 are disposed to cover the two opposite sides of the wire harness connector 352 to protect left and right side surfaces of the wire harness connector 352 and prevent the connector from being damaged by external impact or vibration.

The fourth cover plate 518 is disposed in parallel with the first cover plate 512 and disposed at the other side of the wire harness connector 352, and the fourth cover plate 518 is connected to the pair of third cover plates 516.

The fourth cover plate 518 covers the other side of the wire harness connector 352, thereby preventing external foreign substances or the lubricant applied onto the worm wheel gear 364 from being introduced into the wire harness connector 352.

In addition, the fourth cover plate 518 includes an insertion portion 530 into which the wire harness connector 352 is fitted to maintain a fixed position of the wire harness connector 352.

The insertion portion 530 is formed in the fourth cover plate 518 and formed in a shape opened inward so that the wire harness connector 352 may be inserted into the insertion portion 530.

The insertion portion 530 has a dimension and shape corresponding to an external shape of the wire harness connector 352 and serves to cover the other side of the wire harness connector 352.

In addition, the insertion portion 530 may be formed to be tightly attached to an outer peripheral surface of the wire harness connector 352 to prevent a motion of the wire harness connector 352, thereby preventing the wire harness connector 352 from being dislodged or swayed by vibration or external impact that occurs while the vehicle travels after being assembled.

Therefore, the cover part 510 provides a structure in which the first cover plate 512, the second cover plate 514, the third cover plates 516, and the fourth cover plate 518 are organically coupled and surround multiple upper, lower, front, rear, left, and right areas of the torque sensor 108 and the wire harness connector 352, thereby effectively protecting the torque sensor 108 and the wire harness connector 352 from external foreign substances, lubricant permeation, impact, vibration, and the like.

Next, the cover part 510 includes one or more fixing portions 540 formed on the first cover plate 512 in a circumferential direction and supported on the cover housing 320 or the gearbox housing 310.

In addition, the cover part 510 includes one or more anti-movement portions 548 formed on the first cover plate 512 in the circumferential direction by a slit-shaped cut-out grooves 542 to prevent the torque sensor 108 from moving in a radial direction.

The anti-movement portion 548 is formed by expanding a predetermined portion of the first cover plate 512 in the radial direction, and the anti-movement portion 548 is supported on an inner surface of the cover housing 320 or an inner surface of the gearbox housing 310 and prevents a radial movement of the torque sensor 108.

Further, the cover part 510 includes one or more fixing portions 540 formed on the first cover plate 512 in the circumferential direction by slit-shaped cut grooves 542. The fixing portion 540 includes the elastic deformable portion 544 supported on the cover housing 320 or the gearbox housing 310.

The elastic deformable portion 544 is formed by expanding a predetermined portion of the first cover plate 512 outward in the radial direction. The elastic deformable portion 544 is supported on the other side surface of the cover housing 320 or one side surface of the gearbox housing 310 to prevent the torque sensor 108 from rotating in the rotation direction of the input shaft 332 or the output shaft 336.

In this case, the anti-movement portions 548 and the elastic deformable portions 544 are alternately arranged on the first cover plate 512 in the circumferential direction and supported on the cover housing 320 or the gearbox housing 310 to prevent the torque sensor 108 from moving in the radial direction or rotating in the rotation direction of the input shaft 332 or the output shaft 336.

In this case, the fixing portion 540 according to the embodiment may include a protruding portion 546 protruding from one side of the one or more elastic deformable portions 544 toward the cover housing 320 and supported on the cover housing 320 by the restoring force of the one or more elastic deformable portions 544.

With reference to FIG. 11, the protruding portion 546 extends from the elastic deformable portion 544 of the first cover plate 512 and is formed to be tightly attached to and supported on a corresponding position on the cover housing 320 by a force generated when the elastic deformable portion 544 is restored after being deformed during an assembling process.

Therefore, the anti-rotation member 500 may be stably fixed to the cover housing 320 even without requiring a separate fastening means during the assembling process.

That is, the protruding portion 546 is consistently pressed against the cover housing 320 by the restoring force of the elastic deformable portion 544, thereby preventing dislodgement or displacement caused by external vibration or loads even after the assembling process.

Alternatively, the fixing portion 540 may include a protruding portion 547 protruding from the other side of the one or more elastic deformable portions 544 toward the gearbox housing 310 and supported on the gearbox housing 310 by the restoring force of the one or more elastic deformable portions 544.

With reference to FIG. 12, the protruding portion 547 extends from the elastic deformable portion 544 of the first cover plate 512 and is formed to be tightly attached to and supported on a corresponding position on the gearbox housing 310 by the force generated when the elastic deformable portion 544 is restored after being deformed during the assembling process.

Therefore, the anti-rotation member 500 according to another embodiment may be stably fixed to the gearbox housing 310 even without requiring a separate fastening means during the assembling process.

That is, the protruding portion 547 is consistently pressed against the gearbox housing 310 by the restoring force of the elastic deformable portion 544, thereby preventing dislodgement or displacement caused by external vibration or loads even after the assembling process.

In this case, the fixing portions 540 are alternately arranged in the circumferential direction at one side and the other side of the plurality of elastic deformable portions 544. The fixing portion 540 may include the protruding portion 546 or 547 supported on the cover housing 320 or the gearbox housing 310 by the restoring force of the elastic deformable portion 544.

In the present embodiment, the cover housing 320 may include a protruding portion 322 protruding toward the first cover plate 512 from a position corresponding to the fixing portion 540, the protruding portion 322 being configured to press the one or more elastic deformable portions 544 in a direction toward the gearbox housing 310.

The protruding portion 322 protrudes toward the first cover plate 512 from the position on the cover housing 320 corresponding to the fixing portion 540, and the protruding portion 322 serves to press the elastic deformable portion 544, which is formed on the first cover plate 512, in the direction toward the gearbox housing 310.

Specifically, the protruding portion 322 of the cover housing 320 induces the elastic deformation of the elastic deformable portion 544 during the assembling process, such that the protruding portion 322 presses the elastic deformable portion 544 in the direction toward the gearbox housing 310 so that the elastic deformable portion 544 is tightly attached to the gearbox housing 310 by the restoring force.

Therefore, the anti-rotation member 500 may be stably supported on the cover housing 320 and the gearbox housing 310, thereby more securely ensuring the position stability of the torque sensor 108 and the anti-rotation function.

In addition, in the present embodiment, the gearbox housing 310 may include a protruding portion 312 protruding toward the first cover plate 512 from a position corresponding to the fixing portion 540, the protruding portion 312 being configured to press the one or more elastic deformable portions 544 in a direction toward the cover housing 320.

The protruding portion 312 protrudes toward the first cover plate 512 from the position on the gearbox housing 310 corresponding to the fixing portion 540, and the protruding portion 312 serves to press the elastic deformable portion 544, which is formed on the first cover plate 512, in the direction toward the cover housing 320.

Specifically, the protruding portion 312 of the gearbox housing 310 induces the elastic deformation of the elastic deformable portion 544 during the assembling process, such that the protruding portion 312 presses the elastic deformable portion 544 in the direction toward the cover housing 320 so that the elastic deformable portion 544 is tightly attached to the cover housing 320 by the restoring force.

Therefore, the anti-rotation member 500 may be stably supported on the cover housing 320 and the gearbox housing 310, thereby more securely ensuring the position stability of the torque sensor 108 and the anti-rotation function.

Further, the cover part 510 of the present embodiment includes a support portion 520 formed in the second cover plate 514 and provided in the form of a groove opened in a direction toward the torque sensor 108, the support portion 520 having seating surfaces 522 formed to face each other in the circumferential direction. The torque sensor 108 includes a pair of catching protrusion portions 410a and 410b protruding radially outward from a body part 400 of the torque sensor 108 and provided to be symmetric with respect to a centerline C that passes through a rotation center (or ‘rotational axis’) of the pinion shaft 114, the pair of catching protrusion portions 410a and 410b being elastically deformed and supported on the support portion 520 to prevent the torque sensor 108 from rotating in the rotation direction of the input shaft 332 or the output shaft 336.

As used herein, the term “rotation axis” (also referred to in some places as “rotation center”) refers to the central axis about which a rotatable component, such as the pinion shaft, input shaft, or output shaft, turns during operation. The rotation axis defines the geometric center of angular motion of the corresponding shaft and is coincident with the central longitudinal axis of the shaft. Accordingly, when the present disclosure describes “a centerline C that passes through a rotation axis of the pinion shaft,” this denotes a line corresponding to the central rotational axis of the pinion shaft rather than a single point.

The support portion 520 is formed in the second cover plate 514 and provided in the form of a groove opened in the direction toward the torque sensor 108, and the pair of seating surfaces 522 disposed in the circumferential direction are formed to face each other.

The seating surfaces 522 of the support portion 520 are formed to face each other and serve to support the catching protrusion portions 410a and 410b of the torque sensor 108.

The catching protrusion portions 410a and 410b are configured by a material or structure having a predetermined elastic force. The catching protrusion portions 410a and 410b are elastically deformed during the assembling process, and then the catching protrusion portions 410a and 410b are supported on the seating surfaces 522 of the support portion 520 by the restoring force, thereby preventing the body part 400 from rotating in the rotation direction of the input shaft 332 or the output shaft 336.

The catching protrusion portions 410a and 410b are disposed to be opposite to each other in the circumferential direction and respectively supported on the seating surfaces 522 of the support portion 520 formed in the second cover plate 514.

The support portion 520 and the catching protrusion portions 410a and 410b automatically align the position of the body part 400 during the assembling process. After the assembling process, the support portion 520 and the catching protrusion portions 410a and 410b stably maintain the position of the body part 400 so that sensing is performed without an error even though external vibration or impact occurs.

In this case, the pair of catching protrusion portions 410a and 410b include support protrusion portions 412 protruding from ends of the pair of catching protrusion portions 410a and 410b toward the seating surfaces 522, the support protrusion portions 412 being supported on the seating surfaces 522 by the restoring force of the catching protrusion portions 410a and 410b.

The support protrusion portions 412 extend from the distal ends of the catching protrusion portions 410a and 410b toward the seating surfaces 522 and come into contact with the seating surfaces 522 of the support portion 520 during the assembling process.

The support protrusion portions 412 are tightly attached to the seating surfaces 522 by the elastic restoring force of the catching protrusion portions 410a and 410b, such that the entire catching protrusion portions 410a and 410b are stably fixed in the support portion 520.

In this case, the support protrusion portions 412 are each formed in a shape convexly bent toward the seating surfaces 522, thereby minimizing insertion resistance during the assembling process. After the assembling process, the support protrusion portions 412 are stably tightly attached to the seating surfaces 522 by the elastic restoring force of the catching protrusion portions 410a and 410b.

In addition, the anti-rotation member 500 of the present embodiment includes a space portion 550 in which the torque sensor 108 is disposed, and an indication portion 560 formed at a position corresponding to the fastening member 370 fastened to the gearbox housing 310 while penetrating the cover housing 320.

The space portion 550 has a shape corresponding to an external shape of the torque sensor 108. The space portion 550 may induce the alignment of the sensor during the assembling process, and the space portion 550 may protect the torque sensor 108 from external impact or lubricant permeation even after the assembling process.

In order to easily identify an alignment position of the anti-rotation member 500 during the assembling process, the indication portion 560 is formed on the first cover plate 512 or the fourth cover plate 518 while corresponding to the position of the fastening member 370 fastened to the gearbox housing 310 while penetrating the cover housing 320.

In order to allow an assembling operator to identify an accurate position of the anti-rotation member 500, the indication portion 560 is configured as a visual marking or opening portion formed at the position corresponding to the fastening member 370 and serves to improve assembling accuracy.

In the electric power steering apparatus 2 of the present embodiment, the alignment position of the anti-rotation member 500 may be quickly and accurately identified by means of the indication portion 560 during the assembling process.

That is, because the operator may identify the accurate position of the fastening member 370 by means of the indication portion 560 during the assembling process, the anti-rotation member 500 may be accurately installed and assembled between the gearbox housing 310 and the cover housing 320 without error.

Therefore, it is possible to prevent in advance a position error or a fastening defect that may occur during the assembling process. Finally, it is possible to improve the performance in protecting the torque sensor 108 and the wire harness connector 352 and improve the signal transmission stability.

In addition, the indication portion 560 may allow a mounted state of the anti-rotation member 500 to be visually and easily inspected even after the fastening process, thereby contributing to improving working efficiency and reliability of the operator in a maintenance step.

Next, the fixing portion 540 according to another embodiment includes a fitting protrusion portion 610 protruding from one side of the one or more elastic deformable portions 544 toward the cover housing 320. The cover housing 320 includes one or more fitting groove portions 620 formed in the circumferential direction at a position corresponding to the fitting protrusion portion 610. When the cover housing 320 is coupled to the gearbox housing 310, the fitting protrusion portion 610 is fitted into the one or more fitting groove portions 620 to prevent the torque sensor 108 from rotating in the rotation direction of the input shaft 332 or the output shaft 336.

The elastic deformable portion 544 is formed by expanding a predetermined portion of the first cover plate 512 outward in the radial direction. The elastic deformable portion 544 is temporarily elastically deformed when the elastic deformable portion 544 is pressed during the assembling process. After the assembling process is completed, the elastic deformable portion 544 is tightly attached to the cover housing 320 or the gearbox housing 310 while being restored to an original shape by the restoring force.

With reference to FIG. 13, the fitting protrusion portion 610 integrally extends from the elastic deformable portion 544. During the assembling process, the fitting protrusion portion 610 is guided and inserted into the fitting groove portion 620, which is provided in the cover housing 320, by the restoring force of the elastic deformable portion 544.

That is, during the process of coupling the gearbox housing 310 and the cover housing 320, the fitting protrusion portion 610 is naturally inserted into the fitting groove portion 620. When the assembling process is completed, a state in which the fitting protrusion portion 610 is fastened to the fitting groove portion 620 is maintained by the elastic force.

Therefore, one or more fitting protrusion portions 610 are formed on the anti-rotation member 500 in the circumferential direction, and one or more fitting groove portions 620 are formed on the cover housing 320 in the circumferential direction and formed at positions corresponding to the fitting protrusion portions 610.

The fitting groove portion 620 may be formed to correspond in size and shape to the fitting protrusion portion 610 so that the fitting protrusion portion 610 is inserted into the fitting groove portion 620.

As described above, according to the electric power steering apparatus 2 according to still another embodiment, when the gearbox housing 310 and the cover housing 320 are coupled with the anti-rotation member 500 interposed therebetween, the fitting protrusion portion 610 may be fitted into the fitting groove portion 620, and the anti-rotation member 500 supported on the cover housing 320 may prevent the torque sensor 108 from rotating in the rotation direction of the input shaft 332 or the output shaft 336.

Next, the fixing portion 540 according to yet another embodiment includes a fitting protrusion portion 710 protruding from the other side of the one or more elastic deformable portions 544 toward the gearbox housing 310. The gearbox housing 310 includes one or more fitting groove portions 720 formed in the circumferential direction at a position corresponding to the fitting protrusion portion 710. When the cover housing 320 is coupled to the gearbox housing 310, the fitting protrusion portion 710 is fitted into the one or more fitting groove portions 720 to prevent the torque sensor 108 from rotating in the rotation direction of the input shaft 332 or the output shaft 336.

The elastic deformable portion 544 is formed by expanding a predetermined portion of the first cover plate 512 outward in the radial direction. The elastic deformable portion 544 is temporarily elastically deformed when the elastic deformable portion 544 is pressed during the assembling process. After the assembling process is completed, the elastic deformable portion 544 is tightly attached to the cover housing 320 or the gearbox housing 310 while being restored to an original shape by the restoring force.

With reference to FIG. 14, the fitting protrusion portion 710 integrally extends from the elastic deformable portion 544. During the assembling process, the fitting protrusion portion 710 is guided and inserted into the fitting groove portion 720, which is provided in the gearbox housing 310, by the restoring force of the elastic deformable portion 544.

That is, during the process of coupling the gearbox housing 310 and the cover housing 320, the fitting protrusion portion 710 is naturally inserted into the fitting groove portion 720. When the assembling process is completed, a state in which the fitting protrusion portion 710 is fastened to the fitting groove portion 720 is maintained by the elastic force.

Therefore, one or more fitting protrusion portions 710 are formed on the anti-rotation member 500 in the circumferential direction, and one or more fitting groove portions 720 are formed on the gearbox housing 310 in the circumferential direction and formed at positions corresponding to the fitting protrusion portions 710.

The fitting groove portion 720 may be formed to correspond in size and shape to the fitting protrusion portion 710 so that the fitting protrusion portion 710 is inserted into the fitting groove portion 720.

As described above, according to the electric power steering apparatus 2 according to yet another embodiment, when the gearbox housing 310 and the cover housing 320 are coupled with the anti-rotation member 500 interposed therebetween, the fitting protrusion portion 710 may be fitted into the fitting groove portion 720, and the anti-rotation member 500 supported on the gearbox housing 310 may prevent the torque sensor 108 from rotating in the rotation direction of the input shaft 332 or the output shaft 336.

According to the present embodiments, the anti-rotation member 500 may be fixed between the gearbox housing 310 and the cover housing 320 and support the torque sensor 108 so as to prevent the torque sensor 108 from rotating in the rotation direction of the input shaft 332 or the output shaft 336 or moving in the radial direction, thereby ensuring the signal transmission stability of the torque sensor 108 and preventing an erroneous operation of the torque sensor 108 even though the torque sensor 108 is used for a long period of time.

In addition, according to the present embodiments, the anti-rotation member 500 may be disposed above the worm wheel gear 364 and cover the wire harness connector 352, thereby effectively preventing external foreign substances or the lubricant applied onto the worm wheel gear 364 from being introduced into the wire harness connector 352.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electric power steering apparatus comprising:
a gearbox housing having one side to which a cover housing is coupled, and the other side to which a rack housing is coupled;
a pinion shaft having an input shaft rotatably coupled to the cover housing, and an output shaft coupled to the input shaft by means of a torsion bar and rotatably coupled to the gearbox housing;
a torque sensor installed on the pinion shaft and configured to detect a relative rotation angle between the input shaft and the output shaft; and
an anti-rotation member coupled to the torque sensor and supported on the gearbox housing or the cover housing to prevent the torque sensor from rotating in a rotation direction of the input shaft or the output shaft.

2. The electric power steering apparatus of claim 1, further comprising a wire harness connector,
wherein the anti-rotation member comprises a cover part formed in a shape surrounding the wire harness connector and the torque sensor to prevent external foreign substances or a lubricant applied onto a worm wheel gear from being introduced into the wire harness connector or the torque sensor.

3. The electric power steering apparatus of claim 2, wherein the cover part comprises:
a first cover plate disposed between the cover housing and the gearbox housing to cover one side of the torque sensor and supported on the cover housing or the gearbox housing;
a second cover plate bent from the first cover plate and extending toward the other side to cover an outer surface of the torque sensor;
a pair of third cover plates bent from the first cover plate and extending toward the other side to cover two opposite sides of the wire harness connector; and
a fourth cover plate formed in parallel with the first cover plate so as to be disposed at the other side of the wire harness connector, the fourth cover plate being coupled to the pair of third cover plates.

4. The electric power steering apparatus of claim 3, wherein the cover part comprises one or more fixing portions formed on the first cover plate in a circumferential direction and supported on the cover housing or the gearbox housing.

5. The electric power steering apparatus of claim 4, wherein the cover part comprises one or more anti-movement portions formed on the first cover plate in the circumferential direction by a slit-shaped cut-out groove to prevent the torque sensor from moving in a radial direction.

6. The electric power steering apparatus of claim 4, wherein the fixing portion comprises one or more elastic deformable portions formed on the first cover plate in the circumferential direction by a slit-shaped cut-out groove, the one or more elastic deformable portions being supported on the cover housing or the gearbox housing.

7. The electric power steering apparatus of claim 6, wherein the fixing portion comprises a protruding portion protruding from one side of the one or more elastic deformable portions toward the cover housing and supported on the cover housing by a restoring force of the one or more elastic deformable portions.

8. The electric power steering apparatus of claim 6, wherein the fixing portion comprises a protruding portion protruding from the other side of the one or more elastic deformable portions toward the gearbox housing and supported on the gearbox housing by a restoring force of the one or more elastic deformable portions.

9. The electric power steering apparatus of claim 6, wherein the cover housing comprises a protruding portion protruding toward the first cover plate from a position corresponding to the fixing portion, the protruding portion being configured to press the one or more elastic deformable portions in a direction toward the gearbox housing.

10. The electric power steering apparatus of claim 6, wherein the gearbox housing comprises a protruding portion protruding toward the first cover plate from a position corresponding to the fixing portion, the protruding portion being configured to press the one or more elastic deformable portions in a direction toward the cover housing.

11. The electric power steering apparatus of claim 6, wherein the fixing portion comprises a fitting protrusion portion protruding from one side of the one or more elastic deformable portions toward the cover housing,
wherein the cover housing comprises one or more fitting groove portions formed in the circumferential direction at positions corresponding to the fitting protrusion portions, and
wherein the fitting protrusion portion is fitted into the one or more fitting groove portions when the cover housing is coupled to the gearbox housing to prevent the torque sensor from rotating in the rotation direction of the input shaft or the output shaft.

12. The electric power steering apparatus of claim 6, wherein the fixing portion comprises a fitting protrusion portion protruding from the other side of the one or more elastic deformable portions toward the gearbox housing,
wherein the gearbox housing comprises one or more fitting groove portions formed in the circumferential direction at positions corresponding to the fitting protrusion portions, and
wherein the fitting protrusion portion is fitted and supported into the one or more fitting groove portions when the cover housing is coupled to the gearbox housing to prevent the torque sensor from rotating in the rotation direction of the input shaft or the output shaft.

13. The electric power steering apparatus of claim 3, wherein the cover part comprises a support portion formed in the second cover plate and provided in the form of a groove opened in a direction toward the torque sensor, the support portion having seating surfaces formed to face each other in a circumferential direction, and
wherein the torque sensor comprises a pair of catching protrusion portions protruding radially outward from a body part of the torque sensor and provided to be symmetric with respect to a centerline corresponding to a rotational axis of the pinion shaft, the pair of catching protrusion portions being elastically deformed and supported on the support portion to prevent the torque sensor from rotating in the rotation direction of the input shaft or the output shaft.

14. The electric power steering apparatus of claim 13, wherein the pair of catching protrusion portions comprise support protrusion portions protruding from ends of the pair of catching protrusion portions toward the seating surfaces and supported on the seating surfaces by a restoring force of the catching protrusion portions.

15. The electric power steering apparatus of claim 3, wherein the fourth cover plate comprises an insertion portion into which the wire harness connector is fitted to maintain a fixed position of the wire harness connector.

16. A vehicle comprising:
a traveling route setting part;
a steering angle determining part configured to determine a steering angle based on a traveling route set by the traveling route setting part; and
an electric power steering apparatus configured to assist an operating force of a steering wheel or perform steering based on the steering angle determined by the steering angle determining part,
wherein the electric power steering apparatus comprises:
a gearbox housing having one side to which a cover housing is coupled, and the other side to which a rack housing is coupled;
a pinion shaft having an input shaft rotatably coupled to the cover housing, and an output shaft coupled to the input shaft by means of a torsion bar and rotatably coupled to the gearbox housing;
a torque sensor installed on the pinion shaft and configured to detect a relative rotation angle between the input shaft and the output shaft; and
an anti-rotation member coupled to the torque sensor and supported on the cover housing or the gearbox housing to prevent the torque sensor from rotating in a rotation direction of the input shaft or the output shaft.

17. The vehicle of claim 16, further comprising a wire harness connector,
wherein the anti-rotation member comprises a cover part formed in a shape surrounding the wire harness connector and the torque sensor to prevent external foreign substances or a lubricant applied onto a worm wheel gear from being introduced into the wire harness connector or the torque sensor.

18. The vehicle of claim 17, wherein the cover part comprises:
a first cover plate disposed between the cover housing and the gearbox housing to cover one side of the torque sensor and supported on the cover housing or the gearbox housing;
a second cover plate bent from the first cover plate and extending toward the other side to cover an outer surface of the torque sensor;
a pair of third cover plates bent from the first cover plate and extending toward the other side to cover two opposite sides of the wire harness connector; and
a fourth cover plate formed in parallel with the first cover plate so as to be disposed at the other side of the wire harness connector, the fourth cover plate being coupled to the pair of third cover plates.

19. The vehicle of claim 18, wherein the cover part comprises one or more fixing portions formed on the first cover plate in a circumferential direction and supported on the cover housing or the gearbox housing.

20. The vehicle of claim 18, wherein the cover part comprises a support portion formed in the second cover plate and provided in the form of a groove opened in a direction toward the torque sensor, the support portion having seating surfaces formed to face each other in a circumferential direction, and
wherein the torque sensor comprises a pair of catching protrusion portions protruding radially outward from a body part and provided to be symmetric with respect to a centerline corresponding to a rotational axis of the pinion shaft, the pair of catching protrusion portions being elastically deformed and supported on the support portion to prevent the torque sensor from rotating in the rotation direction of the input shaft or the output shaft.
